(19) United States
(12) Patent Application Publication
(10) Pub. No.: US 2024/0401833 A1
(43) Pub. Date: Dec. 5, 2024

(54) BUILDING MANAGEMENT SYSTEM WITH AI-BASED SELF-OPTIMIZATION AND SELF-HEALING

(71) Applicant: Tyco Fire & Security GmbH, Neuhausen am Rheinfall (CH)

(72) Inventors: Gary W. Gavin, Franklin, WI (US); Abu Bakr Khan, Franklin, WI (US); Gregory M. Makowski, Los Altos, CA (US); Sastry KM Malladi, Fremont, CA (US); Thomas M. Seneczko, Milwaukee, WI (US); Karl F. Reichenberger, Mequon, WI (US); Vineet Binodshanker Sinha, Brookfield, WI (US); Matthew J. Asmus, Watertown, WI (US); Kaleb Luedtke, West Bend, WI (US); Daniel J. Brandt, Milwaukee, WI (US)

(21) Appl. No.: 18/680,865

(22) Filed: May 31, 2024

Related U.S. Application Data
(60) Provisional application No. 63/470,831, filed on Jun. 2, 2023.

(51) Int. Cl. F24F 11/64; F24F 11/30; G05B 13/02

(52) U.S. Cl. CPC F24F 11/64; F24F 11/30; G05B 13/0265

(57) ABSTRACT

Systems and methods are disclosed relating to building management systems with building equipment servicing. For example, a system can include at least one machine learning model configured using training data that includes at least one of unstructured data or structured data regarding items of equipment. The system can provide inputs, such as prompts, to the at least one machine learning model regarding an item of equipment, and generate, according to the inputs, responses regarding the item of equipment, such as responses for detecting a cause of an issue of the item of equipment, performing a service operation corresponding to the cause, or guiding a user through the service operation.

### CROSS-REFERENCE TO RELATED PATENT APPLICATIONS

This application claims the benefit of and priority to U.S. Provisional Patent Application No. 63/470,831, filed on Jun. 2, 2023, the entirety of which is incorporated by reference herein.

### BACKGROUND

This application relates generally to a building system of a building. This application relates more particularly to systems for managing and processing data of the building system.

Building management systems are often complex systems having a large number of devices, data points, parameters, etc. Configuration and optimization of such devices can be a cumbersome, manual, and costly process, and may require a substantial amount of manual user intervention both at initial commissioning and during operation to ensure good performance of the building systems.

### SUMMARY

One or more aspects relate to building management systems and methods that implement, for example, building equipment servicing, optimization, self-healing, etc. For example, a system can include at least one machine learning model configured using training data that includes at least one of unstructured data or structured data regarding items of equipment. The system can provide inputs, such as prompts, to the at least one machine learning model regarding an item of equipment, and generate, according to the inputs, responses regarding the item of equipment, such as responses for detecting a cause of an issue of the item of equipment, performing a service operation corresponding to the cause, or guiding a user through the service operation. The machine learning model can include various machine learning model architectures (e.g., networks, backbones, algorithms, etc.), including but not limited to language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

At least one aspect relates to a system. The system can include one or more processors configured to receive training data. The training data can include at least one of a structured data or unstructured data regarding one or more items of equipment. The system can apply the training data as input to at least one neural network. Responsive to the input, the at least one neural network can generate a candidate output. The system can evaluate the candidate output relative to the training data, and update the at least one neural network responsive to the evaluation.

At least one aspect relates to a method. The method can include receiving, by one or more processors, training data. The training data can include at least one of a structured data or unstructured data regarding one or more items of equipment. The method can include applying, by the one or more processors, the training data as input to a neural network. The method can include generating, by the neural network responsive to the input, a candidate output. The method can include evaluating the candidate output relative to the training data. The method can include updating the at least one neural network responsive to the evaluation.

At least one aspect relates to a system. The system can include one or more processors configured to receive a prompt indicative of an item of equipment. The system can provide the prompt as input to a neural network. The neural network can be configured according to training data regarding example items of equipment, the training data comprising natural language data. The neural network can generate an output relating to the item of equipment responsive to processing the prompt using the transformer.

At least one aspect relates to a method. The method can include receiving, by one or more processors, a prompt indicative of an item of equipment. The method can include providing, by the one or more processors, the prompt as input to a neural network configured according to natural language data regarding example items of equipment. The method can include generating, by the one or more processors using the neural network, an output relating to the item of equipment responsive to processing the prompt.

At least one aspect relates to a method. The method can include receiving, by one or more processors, data relating to one or more pieces of building equipment. The method can further include analyzing, by the one or more processors using an AI model, the data and identifying at least one of an issue relating to the one or more pieces of building equipment or one or more potential improvements to an operation of the one or more pieces of building equipment. The method can further include generating, by the one or more processors using the AI model, one or more updated operating parameters for the one or more pieces of building equipment based on the analysis. In some embodiments, the AI model includes a generative AI model (e.g., a generative large language model (LLM)). In some embodiments, generating the one or more updated parameters includes self-healing the issue with the building equipment based on the analysis of the AI model and/or implementing at least one of the one or more potential improvements.

At least one aspect relates to a method. The method can include receiving, by one or more processors, data relating to one or more pieces of building equipment. The method can include analyzing, by the one or more processors using an artificial intelligence (AI) model, the data and identifying an issue relating to the one or more pieces of building equipment. The method can include generating, by the one or more processors using the AI model, one or more updated operating parameters for the one or more pieces of building equipment based on the analysis.

In some embodiments, the AI model can include a generative AI model.

In some embodiments, the AI mode can include a generative large language model.

In some embodiments, generating the one or more updated parameters can include self-healing the issue with the one or more pieces of building equipment based on the analysis of the AI model.

In some embodiments, generating the one or more updated parameters can include implementing at least one of one or more potential improvements.

In some embodiments, the issue relating to the one or more pieces of building equipment can include issues in collecting information associated with the one or more pieces of building equipment. The method can include retrieving, by the one or more processors, second information associated with the one or more pieces of building equipment. The second information can correspond to one or more points in time prior to the issue relating to the one or more pieces of building equipment. The method can include inputting, by the one or more processors, the second information into the AI model to cause the AI model to generate one or more predictions regarding subsequent performance of the one or more pieces of building equipment. The method can include presenting, by the one or more processors, a user interface that includes an indication of the one or more predictions.

In some embodiments, the issue relating to the one or more pieces of building equipment can include the one or more pieces of building equipment performing at a level below a predetermined threshold. The method can include identifying, by the one or more processors using the AI model, one or more second pieces of building equipment to assist the one or more pieces of building equipment. The method can include generating, by the one or more processors using the AI model, one or more updates to control strategies associated with the one or more pieces of building equipment to account for the one or more second pieces of building equipment.

In some embodiments, generating, by the one or more processors using the AI model, the one or more updated operating parameters for the one or more pieces of building equipment based on the analysis can include retrieving, by the one or more processors, publicly accessible information that corresponds to the one or more pieces of building equipment, extracting, by the one or more processors using the AI model, information that identifies given operations performable by the one or more pieces of building equipment, generating, by the one or more processors using the AI model, a data model to represent the one or more pieces of building equipment, and simulating, by the one or more processors, performance of the given operations by adjusting one or more inputs to the data model.

At least one aspect relates to a system. The system can include one or more memory devices. The one or more memory devices can store instructions. The instructions can, when executed by one or more processors, cause the one or more processors to receive data relating to one or more pieces of building equipment. The instructions can cause the one or more processors to analyze, using an artificial intelligence (AI) model, the data and identify one or more potential improvements to an operation of the one or more pieces of building equipment. The instructions can cause the one or more processors to generate, using the AI model, one or more updated operating parameters for the one or more pieces of building equipment based on the analysis.

In some embodiments, the AI model can include a generative AI model.

In some embodiments, the AI model can include a generative large language model.

In some embodiments, generating the one or more updated parameters can include self-healing an issue with the one or more pieces of building equipment based on the analysis of the AI model.

In some embodiments, generating the one or more updated parameters comprises implementing at least one of the one or more potential improvements.

In some embodiments, the instructions can cause the one or more processors to retrieve second information associated with the one or more pieces of building equipment. The second information can correspond to one or more points in time prior to an issue relating to the one or more pieces of building equipment. The instructions can cause the one or more processors to input the second information into the AI model to cause the AI model to generate one or more predictions regarding subsequent performance of the one or more pieces of building equipment. The instructions can cause the one or more processors to present a user interface that includes an indication of the one or more predictions.

In some embodiments, the instructions can cause the one or more processors to identify, using the data, an issue relating to the one or more pieces of building equipment. The instructions can cause the one or more processors to identify, using the AI model, one or more second pieces of building equipment to assist the one or more pieces of building equipment. The instructions can cause the one or more processors to generate, using the AI model, one or more updates to control strategies associated with the one or more pieces of building equipment to account for the one or more second pieces of building equipment.

In some embodiments, generate, using the AI model, the one or more updated operating parameters for the one or more pieces of building equipment based on the analysis can include retrieving publicly accessible information that corresponds to the one or more pieces of building equipment, extracting using the AI model, information that identifies given operations performable by the one or more pieces of building equipment, generating, using the AI model, a data model to represent the one or more pieces of building equipment, and simulating performance of the given operations by adjusting one or more inputs to the data model.

At least one aspect relates to one or more non-transitory storage media. The one or more non-transitory storage media can store instructions. The instructions can, when executed by one or more processors, cause the one or more processors to perform operations that include receiving data relating to one or more pieces of building equipment. The operations can include analyzing, using an artificial intelligence (AI) model, the data and identifying an issue relating to the one or more pieces of building equipment. The operations can include generating, using the AI model, one or more updated operating parameters for the one or more pieces of building equipment based on the analysis.

In some embodiments, the AI model can include a generative AI model.

In some embodiments, the AI model can include a generative large language model.

In some embodiments, generating the one or more updated parameters can include self-healing the issue with the one or more pieces of building equipment based on the analysis of the AI model.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for equipment servicing applications.

FIG. 2 is a block diagram of an example of a language model-based system for equipment servicing applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of implementing generative artificial intelligence architectures and validation processes for machine learning algorithms for building management systems.

FIG. 9 is a flow diagram of a method to generate parameters for pieces of building equipment.

### DETAILED DESCRIPTION

Referring generally to the FIGURES, systems and methods in accordance with the present disclosure can implement various systems to precisely generate data relating to operations to be performed for managing building systems and components and/or items of equipment, including heating, ventilation, cooling, and/or refrigeration (HVAC-R) systems and components. For example, various systems described herein can be implemented to more precisely generate data for various applications including, for example and without limitation, virtual assistance for supporting technicians responding to service requests; generating technical reports corresponding to service requests; facilitating diagnostics and troubleshooting procedures; recommendations of services to be performed; recommendations for products or tools to use or install as part of service operations; optimization of building equipment; and/or self-healing or automated intervention to address issues with building equipment. Various such applications can facilitate both asynchronous and real-time service operations, including by generating text data for such applications based on data from disparate data sources that may not have predefined database associations amongst the data sources, yet may be relevant at specific steps or points in time during service operations and/or optimization/self-healing.

In some systems, service operations can be supported by text information, such as predefined text documents such as service, diagnostic, and/or troubleshooting guides. Various such text information may not be useful for specific service requests and/or technicians performing the service. For example, the text information may correspond to different items of equipment or versions of items of equipment to be serviced. The text information, being predefined, may not account for specific technical issues that may be present in the items of equipment to be serviced.

AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data. In some instances, relatively large LLMs, such as LLMs having billions or trillions of parameters, may be less agile in responding to novel queries or applications. In addition, various LLMs may lack transparency, such as to be unable to provide to a user a conceptual/semantic-level explanation of a given output was generated and/or selected relative to other possible outputs.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from technician service reports in various formats, including various modalities and/or multi-modal formats (e.g., text, speech, audio, image, and/or video). The system can facilitate automated, flexible customer report generation, such as by processing information received from service technicians and other users into a standardized format, which can reduce the constraints on how the user submits data while improving resulting reports. The system can couple unstructured service data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend detection operations to facilitate more timely assignment of technicians, scheduling of technicians based on expected times for jobs, and provisioning of trucks, tools, and/or parts. The system can perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for fault detection and servicing processes in which a machine learning model is configured based on connecting or relating unstructured data and/or semantic data, such as human feedback and written/spoken reports, with time-series product data regarding items of equipment, so that the machine learning model can more accurately detect causes of alarms or other events that may trigger service responses. For instance, responsive to an alarm for a chiller, the system can more accurately detect a cause of the alarm, and generate a prescription (e.g., for a service technician) for responding to the alarm; the system can request feedback from the service technician regarding the prescription, such as whether the prescription correctly identified the cause of the alarm and/or actions to perform to respond to the cause, as well as the information that the service technician used to evaluate the correctness or accuracy of the prescription; the system can use this feedback to modify the machine learning models, which can increase the accuracy of the machine learning models. In some implementations, the system can predict the fault condition (e.g., detect an indication of the fault condition prior to the fault condition occurring). The system can determine one or more actions to perform to prevent the fault condition from occurring, such as modifications to equipment operations, or preventative maintenance actions. The system can generate a report, responsive to predicting the fault condition, that identifies the one or more actions

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can enable a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for repairing or inspecting the equipment to identify information that the system can use to detect root causes or other issues. The system can use the interface to present information regarding parts and/or tools to service the equipment, as well as instructions for how to use the parts and/or tools to service the equipment.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

In some implementations, the systems, methods, and features of the present disclosure may be utilized to optimize and/or self-heal building equipment. In some such implementations, an AI model, such as a generative AI model (e.g., generative LLM), may be used to perform multi-variable optimization such that the AI model generates parameters to optimize against multiple variables (e.g., cost, energy usage, carbon emissions or other sustainability goals, comfort metrics, air quality or other health metrics, etc.). In some implementations, the AI model may self-heal issues with building equipment, such as by determining a root cause of an issue and a solution to the root cause and automatically taking actions to implement the solution.

### I. Machine Learning Models for Building Management and Equipment Servicing

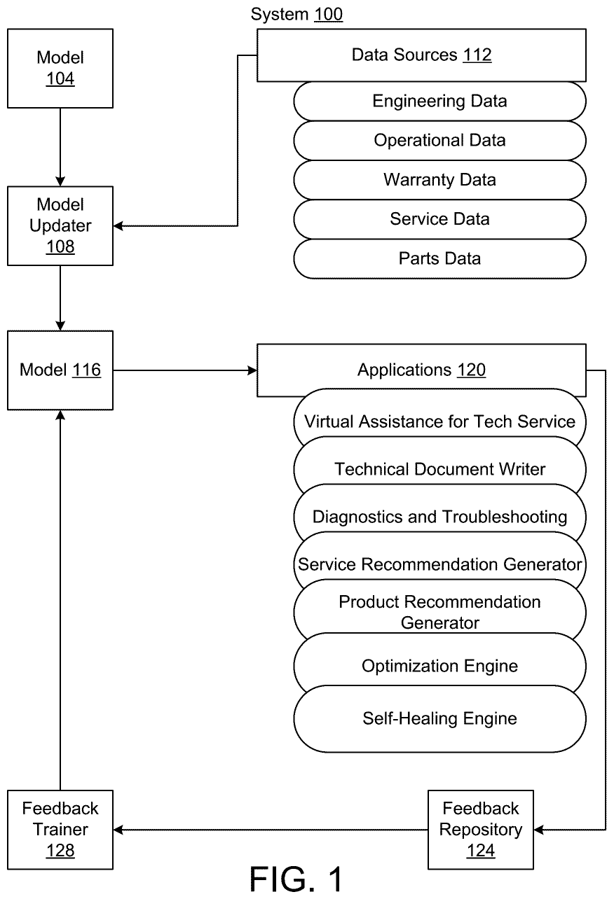

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment servicing operations. In some implementations, the system 100 can be used to implement optimization and/or self-healing features.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence.

The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as technical documents (e.g., service guides) that include both text and image/video information.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers, or is in a predetermined format, such as a database or tabular format). The unstructured data can include one or more data elements that are not in a predetermined format (e.g., are not assigned to fields, or labeled with or assigned with identifiers, that are indicative of a characteristic of the one or more data elements). The data sources 112 can include semi-structured data, such as data assigned to one or more fields that may not specify at least some characteristics of the data, such as data represented in a report having one or more fields to which freeform data is assigned (e.g., a report having a field labeled “describe the item of equipment” in which text or user input describing the item of equipment is provided). The data sources 112 can include data that is incomplete,

For example, using the first model 104 and/or second model 116 to process the data can allow the system 100 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 100 to predict resources to use for performing service as well as when to request service.

The data sources 112 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 112 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 112 can include parts data, including but not limited to parts usage and sales data. For example, the data sources 112 can indicate various parts associated with installation or repair of items of equipment. The data sources 112 can indicate tools for performing service and/or installing parts.

It should be understood that the data sources 112 shown in FIG. 1 are illustrative only and, in various implementations, additional, fewer, or different data sources may be utilized.

The system 100 can include, with the data of the data sources 112, labels to facilitate cross-reference between items of data that may relate to common items of equipment, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., engineering data, operational data, and service data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can enable the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof.

The applications 120 can include user interfaces, dashboards, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for information from users such as service technicians, facility managers, or other occupants, and provide the received responses to at least one of the second model 116 or a root cause detection function (e.g., algorithm, model, data structure mapping inputs to candidate causes, etc.) to determine a prediction of a cause of the issue of the item of equipment and/or solutions. The virtual assistant application 120 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that the problem is with temperature in the space, the system 100 can request, via the virtual assistant application 120, information regarding HVAC-R equipment associated with the space, such as pictures of the space, an air handling unit, a chiller, or various combinations thereof.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a service technician user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 120, etc.), such as to enable the system 100 to update the information generated by the second model 116 for the virtual assistant application 120 according to the engagement. In some implementations, the system 100 can use the second model 116 to detect sentiment of the user of the virtual assistant application 120, and update the second model 116 according to the detected sentiment, such as to improve the experience provided by the virtual assistant application 120.

The applications 120 can include at least one document writer application 120, such as a technical document writer. The document writer application 120 can facilitate preparing structured (e.g. form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment.

In some implementations, the applications 120 can include at least one optimization engine 120. The optimization engine 120 may be configured to analyze data relating to one or more pieces of building equipment and improve or optimize the building equipment. For example, the optimization engine 120 may generate a set of building equipment parameters configured to improve the performance of the building equipment or optimize operation of the building equipment to satisfy one or more goals.

In some embodiments, the optimization engine 120 may analyze or process natural language text or prompts to generate one or more optimization improvements for the building. For example, the optimization engine 120 may receive a prompt that asks, “why is room A always hot in the morning?” and the optimization engine 120 may generate an optimization improvement for the building based on the prompt. The optimization engine 120 may retrieve or access building specs, building layouts, room layouts, geographical data, or BIM models to determine a location of the room A with the building. The optimization engine 120 may determine that room A includes multiple windows that receive several hours of sunlight each day. The optimization engine 120 may generate or update a control schedule for blinds associated with the windows to reduce an amount of heat that is produced as a result of the sunlight.

In some embodiments, the optimization engine 120 may implement a building optimization system (BOS) to monitor changes in the building. For example, the BOS may monitor occupant metrics to determine when to adjust various temperature setpoints of the building. As another example, the BOS may provide insights and/or responses to user queries regarding changes to the building. In some embodiments, the optimization engine 120 may detect intents or sentiments associated with user queries to provide responses to address the user queries.

In some embodiments, the optimization engine 120 may generate control schedules or control strategies to optimize one or more pieces of building equipment. For example, the optimization engine 120 may detect that an air handler unit (AHU) has been or is set to be installed in a given area of the building. The optimization engine 120 may prompt a user for information associated with the AHU. For example, the optimization engine 120 may prompt the user to provide a picture of the AHU. As another example, the optimization engine 120 may prompt the user to indicate where the AHU is located in the building. In some embodiments, the optimization engine 120 may generate a control schedule for the equipment based on locations of the equipment. For example, the optimization engine 120 may generate a first control schedule for a first VAV based on the first VAV being set to service a conference room. As another example, the optimization engine 120 may generate a second control schedule for a second VAV based on the second VAV being set to service a common space.

In some embodiments, the optimization engine 120 may generate one or more data models to represent operations of one or more pieces of building equipment. For example, the optimization engine 120 may retrieve publicly accessible information for a given piece of building equipment to determine what type of timeseries data the given piece of building equipment may produce and/or receive. The optimization engine 120 may generate a data model that simulates operations of the given piece of building equipment by having the data model produce information that replicates information generating during operation of the given piece of building equipment. In some embodiments, the optimization engine 120 may alter or modify the data model based on subsequent information associated with the given piece of building equipment. For example, the optimization engine 120 may input weather information or geographical information to simulate operation in various geographic locations or climates. As another example, the optimization engine 120 may input location information, within a building, to simulate operation of the given piece of building equipment in different locations of the building.

In some embodiments, the optimization engine 120 may determine correlations between building information based on one or more user inputs. For example, the optimization engine 120 may determine correlations between room occupancy and room reservations based on a user input. In this example, the optimization engine 120 may receive one or more user queries indicating that a given room is load. The optimization engine 120 may determine that the user queries are correlated to construction at an adjoining room. The optimization engine 120 may assist the user in reserving a subsequent room that is away from the construction.

In some implementations, the applications 120 can include a self-healing engine 120. The self-healing engine 120 may be configured to analyze data relating to one or more pieces of building equipment and identify a problem with the building equipment. The self-healing engine 120 may determine a root cause of the problem and implement actions to address the problem. In some implementations, the self-healing engine 120 may be implemented in an edge device, such as within the equipment itself. In some implementations, the self-healing engine 120 can be implemented using a software agent.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

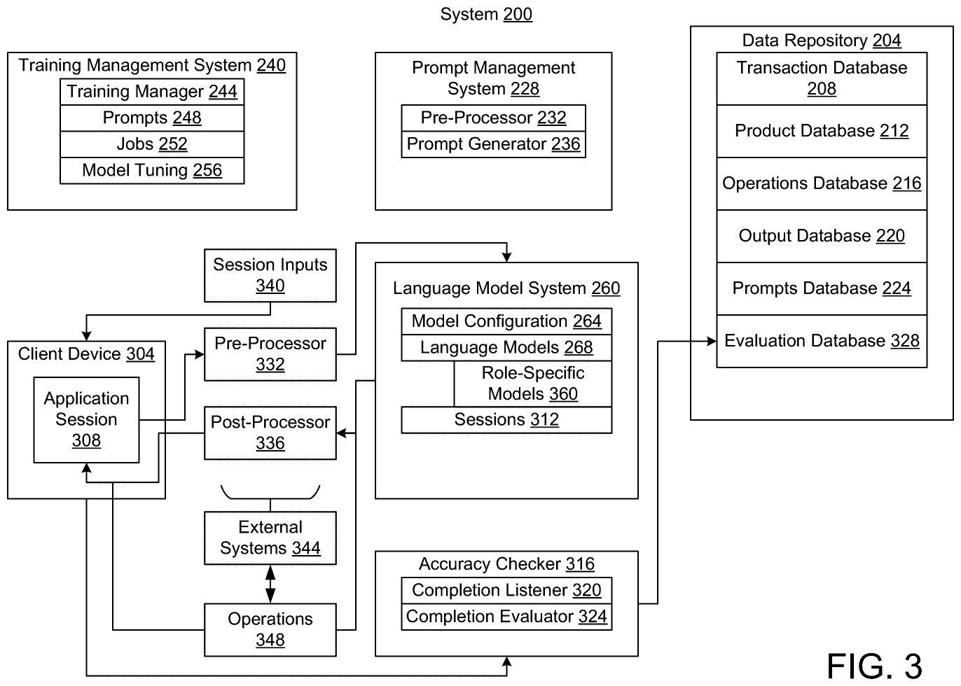

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

II. System Architectures for Generative AI Applications for Building Management System and Equipment Servicing, Equipment/System Optimization, and/or Self-Healing

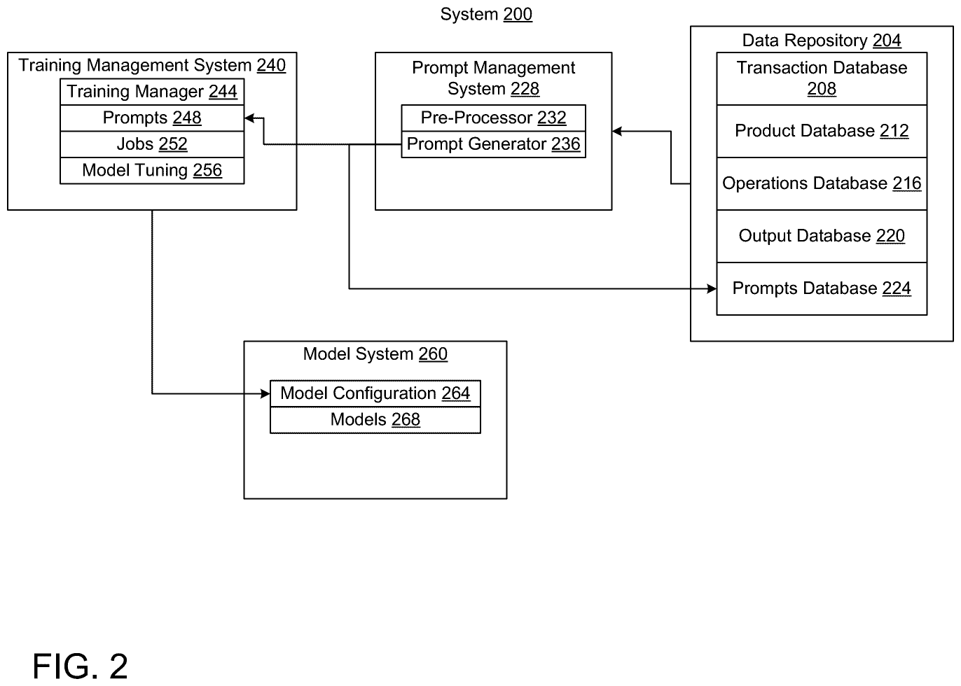

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to enable generative AI applications for building managements systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used for service transactions; sales data indicating various service transactions or other transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 204, and determine training data elements that include examples of input and outputs for generation by machine learning models, such as a training data element that includes a prompt and a completion corresponding to the prompt, based on the data from the data repository 204.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 224. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application session 308, determine a second completion based on the second prompt (which may include at least one of the first prompt or the first completion concatenated to the second prompt), and provide the second completion to the application session 308.

In some implementations, the application session 308 maintains a session state regarding the application session 308. The session state can include one or more prompts received by the application session 308, and can include one or more completions received by the application session 308 from the model system 260. The session state can include one or more items of feedback received regarding the completions, such as feedback indicating accuracy of the completion.

The system 200 can include or be coupled with one or more session inputs 340 or sources thereof. The session inputs 340 can include, for example and without limitation, location-related inputs, such as identifiers of an entity managing an item of equipment or a building or building management system, a jurisdiction (e.g., city, state, country, etc.), a language, or a policy or configuration associated with operation of the item of equipment, building, or building management system. The session inputs 340 can indicate an identifier of the user of the application session 308. The session inputs 340 can include data regarding items of equipment or building management systems, including but not limited to operation data or sensor data. The session inputs 340 can include information from one or more applications, algorithms, simulations, neural networks, machine learning models, or various combinations thereof, such as to provide analyses, predictions, or other information regarding items of equipment. The session inputs 340 can data from or analogous to the data of the data repository 204.

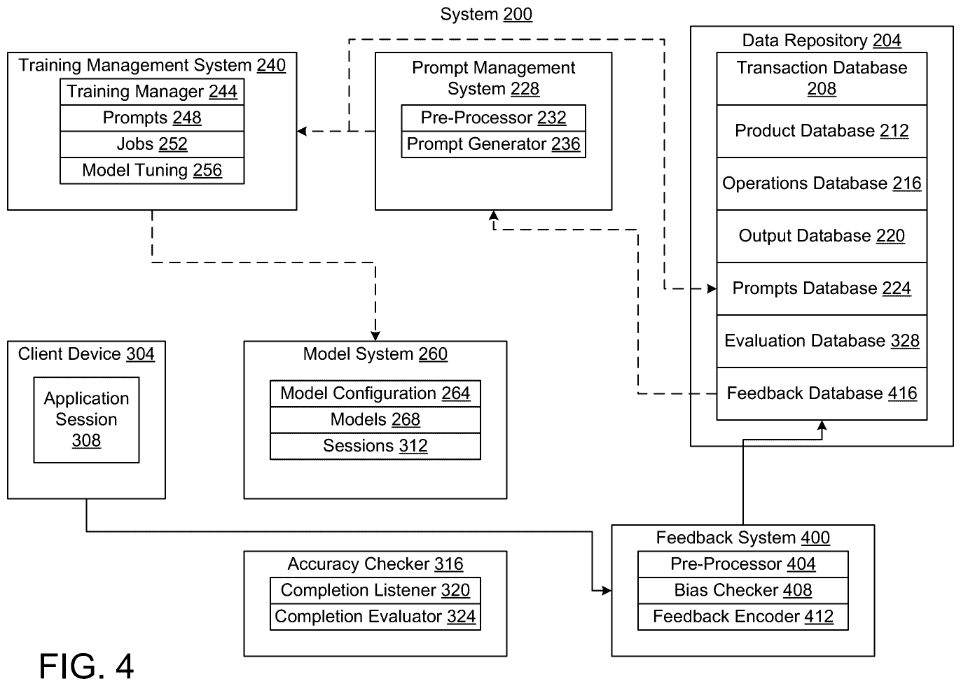

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268. The sessions database 312 can include one or more session states of the application session 308.

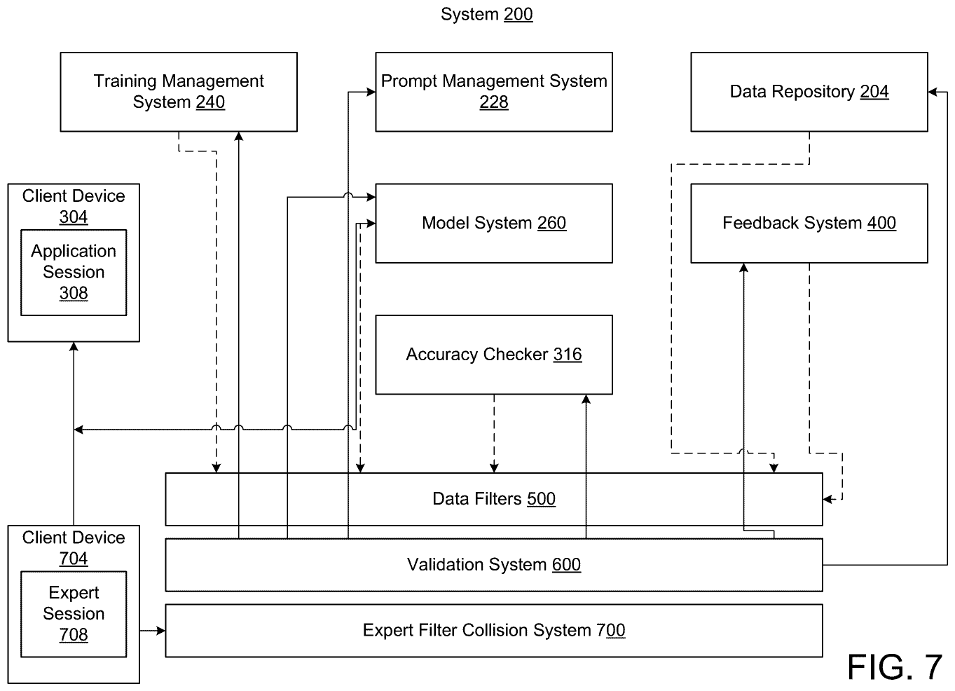

As depicted in FIG. 3, the system 200 can include at least on pre-processor 332. The pre-processor 332 can evaluate the prompt according to one or more criteria and pass the prompt to the model system 260 responsive to the prompt satisfying the one or more criteria, or modify or flag the prompt responsive to the prompt not satisfying the one or more criteria. The pre-processor 332 can compare the prompt with any of various predetermined prompts, thresholds, outputs of algorithms or simulations, or various combinations thereof to evaluate the prompt. The pre-processor 332 can provide the prompt to an expert system (e.g., expert system 700 described with reference to FIG. 7) for evaluation. The pre-processor 332 (and/or post-processor 336 described below) can be made separate from the application session 308 and/or model system 260, which can modularize overall operation of the system 200 to facilitate regression testing or otherwise enable more effective software engineering processes for debugging or otherwise improving operation of the system 200. The pre-processor 332 can evaluate the prompt according to values (e.g., numerical or semantic/text values) or thresholds for values to filter out of domain inputs, such as inputs targeted for jail-breaking the system 200 or components thereof, or filter out values that do not match target semantic concepts for the system 200.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 260 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

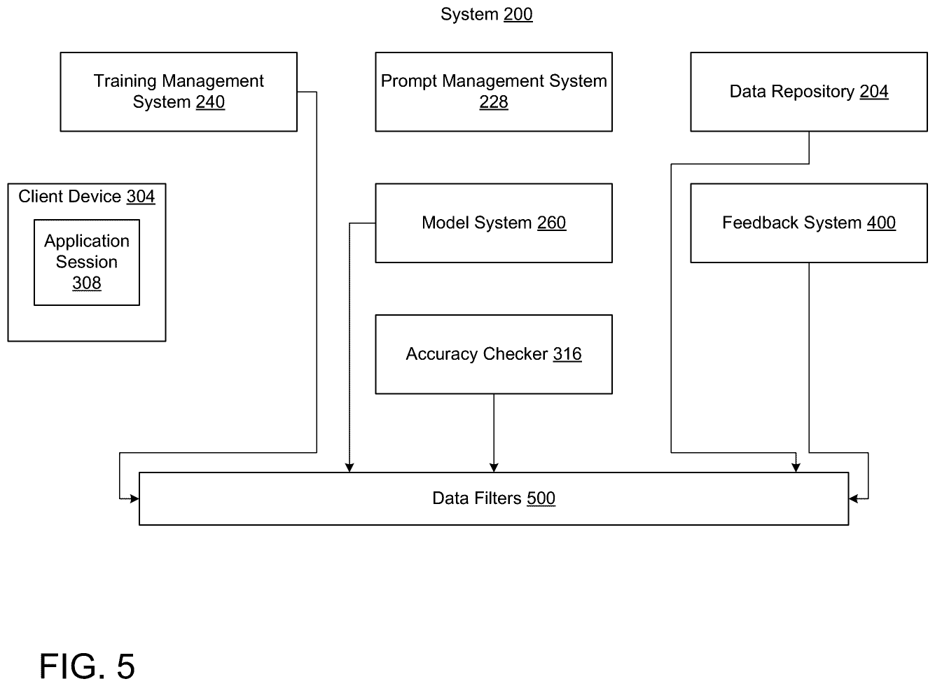

The accuracy checker 316 can include or be coupled with at least one post-processor 336. The post-processor 336 can perform various operations to evaluate, validate, and/or modify the completions generated by the model system 260. In some implementations, the post-processor 336 includes or is coupled with data filters 500, validation system 600, and/or expert system 700 described with reference to FIGS. 5-7. The post-processor 336 can operate with one or more of the accuracy checker 316, external systems 344, operations data 348, and/or role models 360 to query databases, knowledge bases, or run simulations that are granular, reliable, and/or transparent.

Referring further to FIG. 3, the system 200 can include or be coupled with one or more external systems 344. The external systems 344 can include any of various data sources, algorithms, machine learning models, simulations, internet data sources, or various combinations thereof. The external systems 344 can be queried by the system 200 (e.g., by the model system 260) or the pre-processor 332 and/or post-processor 336, such as to identify thresholds or other baseline or predetermined values or semantic data to use for validating inputs to and/or outputs from the model system 260. The external systems 344 can include, for example and without limitation, documentation sources associated with an entity that manages items of equipment.

The system 200 can include or be coupled with operations data 348. The operations data 348 can be part of or analogous to one or more data sources of the data repository 204. The operations data 348 can include, for example and without limitation, data regarding real-world operations of building management systems and/or items of equipment, such as changes in building policies, building states, ticket or repair data, results of servicing or other operations, performance indices, or various combinations thereof. The operations data 348 can be retrieved by the application session 308, such as to condition or modify prompts and/or requests for prompts on operations data 348.

### Role-Specific Machine Learning Models

As depicted in FIG. 3, in some implementations, the models 268 can include or otherwise be implemented as one or more role-specific models 360. The models 360 can be configured using training data (and/or have tuned hyperparameters) representative of particular tasks associated with generating accurate completions for the application sessions 308 such as to perform iterative communication of various language model job roles to refine results internally to the model system 260 (e.g., before/after communicating inputs/outputs with the application session 308), such as to validate completions and/or check confidence levels associated with completions. By incorporating distinct models 360 (e.g., portions of neural networks and/or distinct neural networks) configured according to various roles, the models 360 can more effectively generate outputs to satisfy various objectives/key results.

For example, the role-specific models 360 can include one or more of an author model 360, an editor model 360, a validator model 360, or various combinations thereof. The author model 360 can be used to generate an initial or candidate completion, such as to receive the prompt (e.g., via pre-processor 332) and generate the initial completion responsive to the prompt. The editor model 360 and/or validator model 360 can apply any of various criteria, such as accuracy checking criteria, to the initial completion, to validate or modify (e.g., revise) the initial completion. For example, the editor model 360 and/or validator model 360 can be coupled with the external systems 344 to query the external systems 344 using the initial completion (e.g., to detect a difference between the initial completion and one or more expected values or ranges of values for the initial completion), and at least one of output an alert or modify the initial completion (e.g., directly or by identifying at least a portion of the initial completion for the author model 360 to regenerate). In some implementations, at least one of the editor model 360 or the validator model 360 are tuned with different hyperparameters from the author model 360, or can adjust the hyperparameter(s) of the author model 360, such as to facilitate modifying the initial completion using a model having a higher threshold for confidence of outputted results responsive to the at least one of the editor model 360 or the validator model 360 determining that the initial completion does not satisfy one or more criteria. In some implementations, the at least one of the editor model 360 or the validator model 360 is tuned to have a different (e.g., lower) risk threshold than the author model 360, which can allow the author model 360 to generate completions that may fall into a greater domain/range of possible values, while the at least one of the editor model 360 or the validator model 360 can refine the completions (e.g., limit refinement to specific portions that do not meet the thresholds) generated by the author model 360 to fall within appropriate thresholds (e.g., rather than limiting the threshold for the author model 360).

For example, responsive to the validator model 360 determining that the initial completion includes a value (e.g., setpoint to meet a target value of a performance index) that is outside of a range of values validated by a simulation for an item of equipment, the validator model 360 can cause the author model 360 to regenerate at least a portion of the initial completion that includes the value; such regeneration may include increasing a confidence threshold for the author model 360. The validator model 360 can query the author model 360 for a confidence level associated with the initial completion, and cause the author model 360 to regenerate the initial completion and/or generate additional completions responsive to the confidence level not satisfying a threshold. The validator model 360 can query the author model 360 regarding portions (e.g., granular portions) of the initial completion, such as to request the author model 360 to divide the initial completion into portions, and separately evaluate each of the portions. The validator model 360 can convert the initial completion into a vector, and use the vector as a key to perform a vector concept lookup to evaluate the initial completion against one or more results retrieved using the key.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 404. The pre-processor 404 can perform any of various operations to modify the feedback for further processing. For example, the pre-processor 404 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

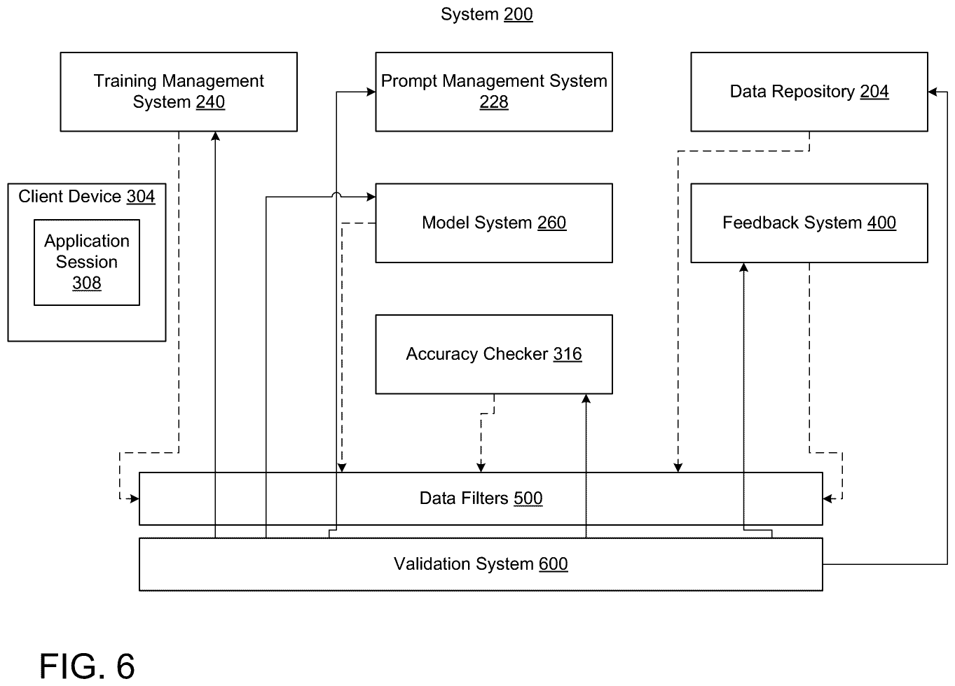

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can enable the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can enable the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some implementations, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some implementations, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can enable the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can enable the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can enable the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert system 700 can enable functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some implementations, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 700 to selectively identify experts to use for monitoring and validating the data.

In some implementations, the expert system 700 facilitates a communication session regarding the data, between the application session 308 and the expert session 708. For example, the expert system 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some implementations, the expert system 700 stores a record of one or more messages or other communications between the application session 308 and the expert session 708 in the data repository 204 to facilitate further configuration of the machine learning models 268 based on the interactions between the users of the application session 308 and the expert session 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to enable the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application No. 202341008712, filed Feb. 10, 2023, the disclosures of which are incorporated herein by reference in their entireties.

III. Generative AI-Based Systems and Methods for Equipment Servicing, Equipment/System Optimization, and/or Self-Healing

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Implementing GAI Architectures for Building Management Systems

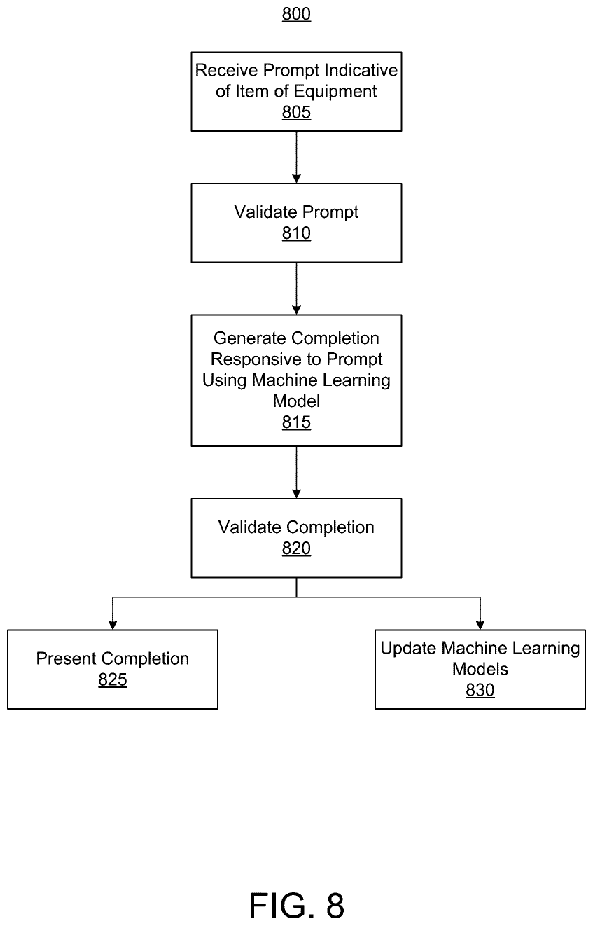

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures. As described with respect to various aspects of the system 200 (e.g., with reference to FIGS. 3-7), the method 800 can implement operations to facilitate more accurate, precise, and/or timely determination of completions to prompts from users regarding items of equipment, such as to incorporate various validation systems to improve accuracy from generative models.

At 805, a prompt can be received. The prompt can be received using a user interface implemented by an application session of a client device. The prompt can be received in any of various data formats, such as text, audio, speech, image, and/or video formats. The prompt can be indicative of an item of equipment, such as a condition of the equipment (e.g., an error detected or fault condition) or a building management system or component thereof. The prompt can indicate a request for a service to perform for the item of equipment. The prompt can indicate one or more characteristics of the item of equipment. In some implementations, the application session provides a conversational interface or chatbot for receiving the prompt, and can present queries via the application to request information for the prompt. For example, the application session can determine that the prompt indicates a type of equipment, and can request information regarding expected issues regarding the equipment (e.g., via iterative generation of completions and communication with machine learning models).

At 810, the prompt is validated. For example, criteria such as one or more rules, heuristics, models, algorithms, thresholds, policies, or various combinations thereof can be evaluated using the prompt. The criteria can be evaluated to determine whether the prompt is appropriate for the item of equipment. In some implementations, the prompt can be evaluated by a pre-processor that may be separate from at least one of the application session or the machine learning models. In some implementations, the prompt can be evaluated using any one or more accuracy checkers, data filters, simulations regarding operation of the item of equipment, or expert validation systems; the evaluation can be used to update the criteria (e.g., responsive to an expert determining that the prompt is valid even if the prompt includes information that does not satisfy the criteria, the criteria can be updated to be capable of being satisfied by the information of the prompt). In some implementations, the prompt is modified according to the evaluation; for example, a request can be presented via the application session for an updated version of the prompt, or the pre-processor can modify the prompt to make the prompt satisfy the one or more criteria. The prompt can be converted into a vector to perform a lookup in a vector database of expected prompts or information of prompts to validate the prompt.

At 815, at least one completion is generated using the prompt (e.g., responsive to validating the prompt). The completion can be generated using one or more machine learning models, including generative machine learning models. For example, the completion can be generated using a neural network comprising at least one transformer, such as GPT model. The completion can be generated using image/video generation models, such as GAN and/or diffusion models. The completion can be generated based on the one or more machine learning models being configured (e.g., trained, updated, fine-tuned, etc.) using training data examples representative of information for items of equipment, including but not limited to unstructured data or semi-structured data such as service technician reports, operating manuals, technical data sheets, etc. Prompts can be iteratively received and completions iteratively generated responsive to the prompts as part of an asynchronous and/or conversational communication session.

In some implementations, generating the prompt comprises using a plurality of machine learning models, which may be configured in similar or different manners, such as by using different training data, model architectures, parameter tuning or hyperparameter fine tuning, or various combinations thereof. In some implementations, the machine learning models are configured in a manner representative of various roles, such as author, editor, validation, external data comparison, etc. roles. For example, a first machine learning model can operate as an author model, such as to have relatively fewer/lesser criteria for generating an initial completion responsive to the prompt, such as to require relatively lower confidence levels or risk criteria. A second machine learning model can be configured to have relatively greater/higher criteria, such as to receive the initial completion, process the initial completion to detect one or more data elements (e.g., tokens or combinations of tokens) that do not satisfy criteria of the second machine learning model, and output an alert or cause the first machine learning model to modify the initial completion responsive to the valuation. For example, the editor model can identify a phrase in the initial completion that does not satisfy an expected value (e.g., expected accuracy criteria determined by evaluating the prompt using a simulation), and can cause the first machine learning model to provide a natural language explanation of factors according to which the initial completion was determined, such as to present such explanations via the application session. The machine learning models can evaluate the completions according to bias criteria. The machine learning models can store the completions and prompts as data elements for further configuration of the machine learning models (e.g., positive/negative examples corresponding to the prompts).

At 820, the completion can be validated. The completion can be validated using various processes described for the machine learning models, such as by comparing the completion to any of various thresholds or outputs of databases or simulations. For example, the machine learning models can configure calls to databases or simulations for the item of equipment indicated by the prompt to validate the completion relative to outputs retrieved from the databases or simulations. The completion can be validated using accuracy checkers, bias checkers, data filters, or expert systems.

At 825, the completion is presented via the application session. For example, the completion can be presented as any of text, speech, audio, image, and/or video data to represent the completion, such as to provide an answer to a query represented by the prompt regarding an item of equipment or building management system. The completion can be presented via iterative generation of completions responsive to iterative receipt of prompts. The completion can be present with a user input element indicative of a request for feedback regarding the completion, such as to enable the prompt and completion to be used for updating the machine learning models.

At 830, the machine learning model(s) used to generate the completion can be updated according to at least one of the prompt, the completion, or the feedback. For example, a training data element for updating the model can include the prompt, the completion, and the feedback, such as to represent whether the completion appropriately satisfied a user's request for information regarding the item of equipment. The machine learning models can be updated according to indications of accuracy determined by operations of the system such as accuracy checking, or responsive to evaluation of completions by experts (e.g., responsive to selective presentation and/or batch presentation of prompts and completions to experts).

System/Equipment Optimization and/or Self-Healing

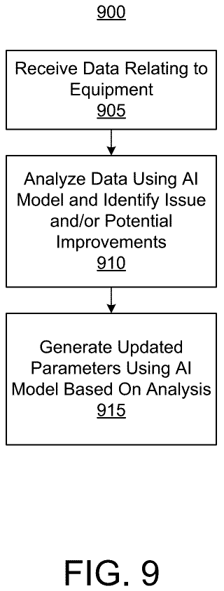

FIG. 9 depicts an example of a method 900. The method 900 can be performed using various devices and systems described herein, including but not limited to the systems 100, 200 or one or more components thereof. Various aspects of the method 900 can be implemented using one or more devices or systems that are communicatively coupled with one another, including client-server, cloud-based, or other network architectures. As described with respect to various aspects of the system 200 (e.g., with reference to FIGS. 3-7), the method 900 can implement operations to facilitate more accurate, precise, and/or timely determination of completions to prompts from users regarding items of equipment, such as to incorporate various validation systems to improve accuracy from generative models.

At 905, data relating to one or more pieces of building equipment may be received. In some implementations, the data may be operational data relating to the building equipment. In some implementations, the data may additional or alternatively be data other than operational data that can provide context regarding the operation of the building equipment, such as operational data of other building equipment, sensor data for the building or a space thereof, data received from a user (e.g., indicating an observed issue, comfort of the user, etc.).

At 910, the data may be analyzed using an AI model, and the AI model may identify an issue and/or potential improvements for the building equipment. In some implementations, the AI model may identify potential improvements to optimize the building equipment, such as to control the building equipment based on meeting one or more goals. In some implementations, the AI model may identify an issue relating to the building equipment and may identify a root cause of the issue. In some such implementations, the AI model may identify one or more actions to implement to address the root cause. In some such implementations, the AI model may automatically implement the actions.

At 915, the AI model may generate updated parameters based on the analysis. In some implementations, the AI model may generate parameters to improve or optimize operation of the building equipment, such as to meet certain goals. In some implementations, the AI model may generate the parameters to self-heal the building equipment, or fix the identified issue based on the determined solution(s) to the root cause.

In various implementations, the AI model may be implemented as a generative AI model, such as a generative large language model (LLM).

In some implementations, the AI model may be configured to automatically tune, optimize, or otherwise improve the operation of one or more pieces of building equipment. For example, the AI model may be configured to tune proportional integral derivative (PID) loops or other types of control algorithms, such as for variable air volume zone loops for particular conditions or goals. In some implementations, the AI model may tune or optimize parameter for a control algorithm for building devices, such as rooftop units (RTUs), air handling units (AHUs), VAVs, etc. for a particular space, such as an office, located on a particular side of a building (e.g., south side) with a window, in Wisconsin, for a particular type of day, season, weather, etc. In some implementations, the AI model may be configured to determine the conditions and/or recommended goals autonomously without requiring user input and/or generate the output parameters to meet the goals and/or accommodate for the conditions autonomously without requiring user input.

In some implementations, the AI model may take as input user feedback regarding one or more goals, or a balance of one or more goals. For example in some implementations, a user interface may be provided allowing the user to identify an absolute or relative amount of emphasis to put on one or more goals, or prioritize between a plurality of goals. In some such implementations, the interface may include a slider, multi-dimensional coordinate system, alphanumeric weighting interface, or other interface allowing the user to indicate a priority between multiple goals, such as between cost, energy usage, carbon emissions or other sustainability metrics, occupant comfort or health metrics, air quality, and/or other factors. In some implementations, the user may be provided with a conversational chat interface through which the user, via text, audio, visual, etc. input can indicate priorities or other input guidance for the model in determining the output parameters. For example, in some implementations, the input may be an unstructured natural language input, such as input that does not conform to a predetermined query ontology or input that conforms to a plurality of different query ontologies. In some such implementations, the model may be a generative AI model such as a generative large language model (LLM) (e.g., a generative AI chat model). In some implementations, one or more simulation models (e.g., AI or other machine learning models) may generate output simulation data, and the output simulation data may be used to train the AI model (e.g., a generative AI model trained using the simulation output, alone or in combination with other data).

In some implementations, the tuning/optimization could be performed by the AI model based on recognition of patterns of behavior. In some implementations, the AI model could utilize building equipment operating data, schedule data, data from users, or other types of data to identify an occupancy pattern for a particular space, such as that a space is unoccupied by its occupant, or by any occupants, during a particular timeframe, certain days (e.g., due to remote work or vacations), etc. and change the operating parameters in response (such as lowering or raising a thermostat setpoint or taking other actions to reduce energy usage, cost, etc.).

In some implementations, the AI model tuning/optimization engine could undergo a training period, such as at the beginning of usage of a new space, beginning of a new school term, beginning of a calendar or fiscal year or season, etc. during which the AI model learns patterns of behavior/usage of occupants, equipment, spaces, etc. For example, at the beginning of a school year, an AI model configured to tune building equipment in a school may monitor behavior for a period of time, such as a month, and then optimize parameters based on the observed behavior for different spaces. This may allow the operation of the devices to continually adapt as the usage may change from school year to school year, particularly if certain classrooms or other spaces are repurposed from year to year (e.g., changed from a kindergarten to a fifth grade classroom). In some implementations, the AI model can proactively predict where trends in building equipment operation may be heading based on observed behavior in the data relating to the building equipment and/or other data, such as data relating to building equipment of other buildings. In some such implementations, the AI model may proactively modify the parameters to change the operation in anticipation of the predicted future trend, such as to prevent anticipated suboptimal performance or future issues.

In some implementations, the AI model may tune/optimize parameters based on occupancy. In some such implementations, the AI model may directly observe occupancy levels for one or more spaces through occupancy sensors or other sensors providing direct indications of whether users are in a space. In some implementations, the AI model may use other data as a proxy for whether spaces are occupied and at what level of occupancy, such as a number of times a door opens, cellphone or other electronic equipment signals (personal electronic equipment), carbon dioxide sensors, etc.

In some implementations, the AI model may be used to optimize operation of a central plant of a building. For example, in some implementations, the AI model may receive input (e.g., unstructured natural language input) regarding a desired goal or features of operation of a central utility plant for the building or a set of buildings, and the AI model may set parameters to tune/optimize the operation of the equipment based on the input.

In some implementations, the AI model can use experiments to discover relationships between equipment, such as source-load relationships, by perturbing equipment in a predetermined way and monitoring the response of other equipment. In some such implementations, the AI model can autonomously design the experiments to run to determine the relationships, based on the identified equipment available to the AI model and the data regarding the equipment, and generate data indicating the relationships (e.g., without requiring user intervention). For example, a generative AI model can design a set of experiments to test the equipment relationships and generate the relationship data.

In some implementations, the AI model can detect problems that may not be readily apparent to human observers from the underlying data. For example, in some implementations, a generative AI model can, based on the underlying data in view of the data upon which the AI model is trained, predict a plurality of potential causes of suboptimal operation. In some such implementations, one or more of the potential causes or solutions identified by the AI model may not be causes or solutions that are expressly identified in the input or training data but are causes and/or solutions that the AI model autonomously produces. For example, the AI model could determine that a problem heating or cooling a space may be attributable to hot and cold water pipes to a particular piece of equipment or particular area of the building, even if the underlying operational data does not directly indicate a problem in the plumbing.

In some implementations, the AI model can generate or modify a graphical interface indicating operating levels of different equipment or spaces, such as spaces/equipment that are operating at a high level or near optimal operation (e.g., above a first threshold level of operation), spaces/equipment that are operating at a medium level (e.g., below the first threshold level of operation and above a second threshold level of operation), and at a low level (e.g., below the second threshold). In some implementations, the operation could be shown in different colors (e.g., green, yellow, and red, respectively) or using other indicators. In some implementations, the data could be shown in a building information model (BIM) view, such as a 2D BIM view or floorplan or a 3D BIM view), or could be represented in some other fashion. In some implementations, the AI model can indicate information about the cause of the suboptimal operation of particular spaces/equipment. In some implementations, the AI model can show potential solutions to the determined problems/causes. In some such implementations, the AI model can provide a button or other input allowing the user to select to take an action with respect to such potential solutions, such as approving changes to building parameters or initiating a work order to fix particular equipment. In some such implementations, the AI model can autonomously take action to implement the potential solutions and show the change in operations pre- and post-implementation of the solutions in the graphical view.

In some implementations, the AI model can implement self-healing features to address issues with building equipment. For example, for a chiller, the AI model may determine that a flow of water to the chiller is not correct. The AI model may determine what a likely cause of the lack of flow of water is and how to correct the cause. The AI model can additionally or alternatively determine what other devices may be able to help alleviate the issue either temporarily or permanently, such as by having another chiller work to compensate for the suboptimal chiller. In some implementations, the AI model can be implemented using a software agent to take actions on behalf of the device or system. In some implementations, the AI model (e.g., software agent) may be implemented in an edge device, such as in the building device it is healing/optimizing. For example, an agent can be deployed for flow correction and can determine a corrective action for low flow, such as parameter changes, temperature changes, actions needed from human personnel/technicians, parts to be ordered, and/or other actions. In some implementations, the agents may identify other agents to help fix the problem, such as by taking actions for or controlling other equipment. In some implementations, the AI model can identify backup systems, such as alternative control loops, subsystems, parallel devices, etc. that can handle the loads. In some implementations, the AI model may trigger or provide alerts to trigger human corrective actions such as parts, repairs, changes to other systems, increasing or decreasing parameters, shutting off systems, etc. to address the problem.

In some examples, the device may be an actuator that cannot fully open. In some implementations, the AI model can determine what devices can compensate for the reduced operation of the actuator until the actuator can be repaired or replaced, or other changes to operating parameters to compensate, such as increasing pressure or pump speed. In some implementations, the AI model can determine an estimated impact of the problem, such as estimated energy or performance impact. In some embodiments, the AI model may generate one or more updates to operating parameters. For example, the AI model may generate a control schedule for a piece of equipment that includes a new runtime schedule. As another example, the AI model may generate a data setpoint for the piece of equipment. In some embodiments, the AI model or a BMS that implements the AI model may subsequently control or adjust operation of the pieces of building equipment using the updated operating parameters.

In some implementations, the AI model may ingest data from and/or export data into a digital twin of the building and/or digital twins of entities of the building (spaces, people, equipment, events, etc.). For example, in some implementations, the AI model can be trained using a digital twin of the building as input and use the digital twin as context to identify relationships between equipment and determine relationships or other characteristics that impact the performance level or health of the building devices, and use such context to determine potential root causes and solutions to suboptimal operation or issues with building equipment.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method, comprising:
receiving, by one or more processors, data relating to one or more pieces of building equipment;
analyzing, by the one or more processors using an artificial intelligence (AI) model, the data and identifying an issue relating to the one or more pieces of building equipment; and
generating, by the one or more processors using the AI model, one or more updated operating parameters for the one or more pieces of building equipment based on the analysis.

2. The method of claim 1, wherein the AI model comprises a generative AI model.

3. The method of claim 1, wherein the AI model comprises a generative large language model.

4. The method of claim 1, wherein generating the one or more updated parameters comprises self-healing the issue with the one or more pieces of building equipment based on the analysis of the AI model.

5. The method of claim 1, wherein generating the one or more updated parameters comprises implementing at least one of one or more potential improvements.

6. The method of claim 1, wherein the issue relating to the one or more pieces of building equipment includes issues in collecting information associated with the one or more pieces of building equipment, the method comprising:
retrieving, by the one or more processors, second information associated with the one or more pieces of building equipment, wherein the second information corresponds to one or more points in time prior to the issue relating to the one or more pieces of building equipment;
inputting, by the one or more processors, the second information into the AI model to cause the AI model to generate one or more predictions regarding subsequent performance of the one or more pieces of building equipment; and
presenting, by the one or more processors, a user interface that includes an indication of the one or more predictions.

7. The method of claim 1, wherein the issue relating to the one or more pieces of building equipment includes the one or more pieces of building equipment performing at a level below a predetermined threshold, the method comprising:
identifying, by the one or more processors using the AI model, one or more second pieces of building equipment to assist the one or more pieces of building equipment; and
generating, by the one or more processors using the AI model, one or more updates to control strategies associated with the one or more pieces of building equipment to account for the one or more second pieces of building equipment.

8. The method of claim 1, wherein generating, by the one or more processors using the AI model, the one or more updated operating parameters for the one or more pieces of building equipment based on the analysis includes:
retrieving, by the one or more processors, publicly accessible information that corresponds to the one or more pieces of building equipment;
extracting, by the one or more processors using the AI model, information that identifies given operations performable by the one or more pieces of building equipment;
generating, by the one or more processors using the AI model, a data model to represent the one or more pieces of building equipment; and
simulating, by the one or more processors, performance of the given operations by adjusting one or more inputs to the data model.

9. A system comprising one or more memory devices storing instructions thereon that, when executed by one or more processors, cause the one or more processors to:
receive data relating to one or more pieces of building equipment;
analyze, using an artificial intelligence (AI) model, the data and identify one or more potential improvements to an operation of the one or more pieces of building equipment; and
generate, using the AI model, one or more updated operating parameters for the one or more pieces of building equipment based on the analysis.

10. The system of claim 9, wherein the AI model comprises a generative AI model.

11. The system of claim 9, wherein the AI model comprises a generative large language model.

12. The system of claim 9, wherein generating the one or more updated parameters comprises self-healing an issue with the one or more pieces of building equipment based on the analysis of the AI model.

13. The system of claim 9, wherein generating the one or more updated parameters comprises implementing at least one of the one or more potential improvements.

14. The system of claim 9, wherein the instructions cause the one or more processors to:
retrieve second information associated with the one or more pieces of building equipment, wherein the second information corresponds to one or more points in time prior to an issue relating to the one or more pieces of building equipment;
input the second information into the AI model to cause the AI model to generate one or more predictions regarding subsequent performance of the one or more pieces of building equipment; and
present a user interface that includes an indication of the one or more predictions.

15. The system of claim 9, wherein the instructions cause the one or more processors to:
identify, using the data, an issue relating to the one or more pieces of building equipment;
identify, using the AI model, one or more second pieces of building equipment to assist the one or more pieces of building equipment; and
generate, using the AI model, one or more updates to control strategies associated with the one or more pieces of building equipment to account for the one or more second pieces of building equipment.

16. The system of claim 9, wherein generate, using the AI model, the one or more updated operating parameters for the one or more pieces of building equipment based on the analysis includes:
retrieving publicly accessible information that corresponds to the one or more pieces of building equipment;
extracting using the AI model, information that identifies given operations performable by the one or more pieces of building equipment;
generating, using the AI model, a data model to represent the one or more pieces of building equipment; and
simulating performance of the given operations by adjusting one or more inputs to the data model.

17. One or more non-transitory storage media storing instructions thereon that, when executed by one or more processors, cause the one or more processors to perform operations comprising:
receiving data relating to one or more pieces of building equipment;
analyzing, using an artificial intelligence (AI) model, the data and identifying an issue relating to the one or more pieces of building equipment; and
generating, using the AI model, one or more updated operating parameters for the one or more pieces of building equipment based on the analysis.

18. The one or more non-transitory storage media of claim 17, wherein the AI model comprises a generative AI model.

19. The one or more non-transitory storage media of claim 17, wherein the AI model comprises a generative large language model.

20. The one or more non-transitory storage media of claim 17, wherein generating the one or more updated parameters comprises self-healing the issue with the one or more pieces of building equipment based on the analysis of the AI model.
